(19) United States
(12) Patent Application Publication
(10) Pub. No.: US 2026/0261461 A1
(43) Pub. Date: Sep. 3, 2026

(54) INTEGRATED SENSING AND COMMUNICATION WAVEFORM GENERATION METHOD AND DEVICE, ELECTRONIC DEVICE, AND MEDIUM

(71) Applicant: Beijing University of Posts and Telecommunications, Beijing (CN)

(72) Inventors: Chuang YANG, Beijing (CN); Hanchen SHI, Beijing (CN); Mugen PENG, Beijing (CN)

(73) Assignee: Beijing University of Posts and Telecommunications, Beijing (CN)

(21) Appl. No.: 18/867,380

(22) PCT Filed: Feb. 29, 2024
(86) PCT No.: PCT/CN2024/079328

§ 371 Date: Nov. 19, 2024

(30) Foreign Application Priority Data
Jul. 20, 2023 (CN) 202310896827.4

(51) Int. Cl. H04L 27/26; H04B 7/0413; H04L 1/20

(52) U.S. Cl. CPC H04L 27/2607; H04B 7/0413; H04L 1/203; H04L 27/2666

(57) ABSTRACT

An integrated sensing and communication waveform generation method and device, an electronic device, and a medium are provided. By constructing a sparse MIMO receiving and transmitting array model and an integrated OFDM transmission signal and reception echo model for the T-ISAC system, the association relationships between communication and sensing performances and the OFDM frame structure and various parameters of the T-ISAC system can be established. Moreover, considering the requirements of 6G application scenes and the association relationships, a method for calculating a feasible region of OFDM frame structure parameters is provided for the T-ISAC system, resulting the construction of integrated waveforms.

### TECHNICAL FIELD

The present application relates to the technology of terahertz data processing, and in particular to an integrated sensing and communication waveform generation method and device, an electronic device, and a medium.

### BACKGROUND

With the increasing amount of global communication data, it is difficult for the millimeter wave frequency bands of 5G microwave to support the high-capacity rate requirements, thus forcing 6G to evolve toward higher frequency bands in the future. Terahertz (THz) spectrum resources are abundant, and ultra large bandwidth can also achieve smaller distance resolution while supporting ultra-high rates. Higher frequencies can also improve velocity resolution, making THz become one of the key technologies of 6G integrated sensing and communication.

In the related art, in order to meet the requirements of THz long-distance communication and sensing business scenes, MIMO technology must be adopted to cope with the problems of low THz transmission power and high path loss. In view of the fixed spacing between traditional uniform line array elements, a sparse MIMO array is adopted to increase the degree of freedom of the array and form a virtual aperture, which can further improve the echo detection ability and angle resolution performance. In addition, the current 3GPP standard has not yet extended the definition of OFDM frame structure to the THz frequency bands, nor has it considered sensing factors. Moreover, the parameterization of communication and sensing performances of integrated OFDM waveforms in existing research is limited to single antenna ideal systems and low order modulation methods, and the characterization results lack completeness. This results in a lack of theoretical guidance for THz integrated waveform design.

Therefore, how to design a method for constructing integrated waveforms is the key to realizing the design of a terahertz integrated sensing and communication (T-ISAC) system.

### SUMMARY

Embodiments of the present application provide an integrated sensing and communication waveform generation method and device, an electronic device, and a medium. The embodiments of the present application are used to solve the problem in the related art that it is impossible to generate integrated waveforms for a T-ISAC system.

According to an aspect of the embodiments of the present application, an integrated sensing and communication waveform generation method is provided, which is applied to a T-ISAC system including a sparse MIMO linear array, and which includes:
acquiring a downlink integrated signal received by a user device and acquiring an integrated signal echo received by the T-ISAC system during a communication process between the T-ISAC system and the user device implemented through the sparse MIMO linear array;
constructing a first association relationship for characterizing a relationship between downlink communication performance of the user device and T-ISAC system parameters based on the downlink integrated signal, and constructing a second association relationship for characterizing a relationship between communication and sensing performances of the user device and the T-ISAC system parameters based on the integrated signal echo, in which the system parameters are system operating parameters required for constructing integrated waveforms; and
obtaining an OFDM frame structure design of the T-ISAC system based on the first association relationship and the second association relationship, and controlling the T-ISAC system to generate integrated waveforms based on the OFDM frame structure design.

Optionally, in another embodiment based on the above method of the present application, the acquiring an integrated signal echo received by the T-ISAC system includes:
acquiring the integrated signal echo emitted after being reflected by the user device and received by the T-ISAC system.

Optionally, in another embodiment based on the above method of the present application, the constructing a first association relationship for characterizing a relationship between downlink communication performance of the user device and T-ISAC system parameters based on the downlink integrated signal includes:
determining a first sub association relationship for reflecting a relationship between an effective transmission rate of a downlink transmission channel and the T-ISAC system parameters, a second sub association relationship between a power spectral density ratio of the downlink transmission channel and the T-ISAC system parameters, a third sub association relationship between a bit error rate of the downlink transmission channel and the T-ISAC system parameters, and a fourth sub association relationship between a communication signal-to-noise ratio of the downlink transmission channel and the T-ISAC system parameters based on communication information carried by the downlink integrated signal; and
taking the first sub association relationship, the second sub association relationship, the third sub association relationship and the fourth sub association relationship as the first association relationship.

Optionally, in another embodiment based on the above method of the present application, the constructing a second association relationship for characterizing a relationship between communication and sensing performances of the user device and the T-ISAC system parameters based on the integrated signal echo includes:
determining a fifth sub association relationship for reflecting a relationship between a distance indicator of the user device and the T-ISAC system, a sixth sub association relationship between a moving velocity indicator of the user device and the T-ISAC system, a seventh sub association relationship between a relative angle indicator of the user device and the T-ISAC system, and an eighth sub association relationship between a total system loss and the T-ISAC system, and a ninth sub association relationship between a sensing signal-to-noise ratio and the T-ISAC system based on communication information carried by the integrated signal echo; and
taking the fifth sub association relationship, the sixth sub association relationship, the seventh sub association relationship the eighth sub association relationship and the ninth sub association relationship as the second association relationship.

Optionally, in another embodiment based on the above method of the present application, the obtaining an OFDM frame structure design of the T-ISAC system based on the first association relationship and the second association relationship includes:
acquiring 6G application scene requirements, and determining a subcarrier spacing, the number of subcarriers, a cyclic prefix ratio, and the number of symbols of the T-ISAC system based on the 6G application scene requirements, the first association relationship, and the second association relationship; and
determining the OFDM frame structure design based on the subcarrier spacing, the number of subcarriers, the cyclic prefix ratio, and the number of symbols of the T-ISAC system.

Optionally, in another embodiment based on the above method of the present application, the determining a subcarrier spacing, the number of subcarriers, a cyclic prefix ratio, and the number of symbols of the T-ISAC system based on the 6G application scene requirements, the first association relationship, and the second association relationship includes:
calculating a parameter feasible region of the OFDM frame structure based on the first association relationship and the second association relationship under the condition of meeting the 6G application scene requirements, in which the parameter feasible region includes the subcarrier spacing, the number of subcarriers, the cyclic prefix ratio, and the number of symbols.

According to another aspect of the embodiments of the present application, an integrated sensing and communication waveform generation device is provided, which is applied to a T-ISAC system including a sparse MIMO linear array, and which includes:
an acquisition module, which is configured to acquire a downlink integrated signal received by a user device and acquire an integrated signal echo received by the T-ISAC system during a communication process between the T-ISAC system and the user device implemented through the sparse MIMO linear array;
a construction module, which is configured to construct a first association relationship for characterizing a relationship between downlink communication performance of the user device and T-ISAC system parameters based on the downlink integrated signal, and construct a second association relationship for characterizing a relationship between communication and sensing performances of the user device and the T-ISAC system parameters based on the integrated signal echo, in which the system parameters are system operating parameters required for constructing integrated waveforms; and
a generation module, which is configured to obtain an OFDM frame structure design of the T-ISAC system based on the first association relationship and the second association relationship, and control the T-ISAC system to generate integrated waveforms based on the OFDM frame structure design.

According to further another aspect of the embodiments of the present application, an electronic device is provided, which includes:
a memory, which is configured to store executable instructions; and
a processor, which is configured to execute the executable instructions with the memory to complete operations of the integrated sensing and communication waveform generation method according to any of the above items.

According to still another aspect of the embodiments of the present application, a computing device readable storage medium is provided, which is configured to store instructions readable by a computing device, and when the instructions are executed, operations of the integrated sensing and communication waveform generation method according to any of the above items are performed.

In the present application, a downlink integrated signal received by the user device is acquired and an integrated signal echo received by the T-ISAC system is acquired during a communication process between the T-ISAC system and the user device implemented through the sparse MIMO linear array; a first association relationship for characterizing a relationship between downlink communication performance of the user device and T-ISAC system parameters is constructed based on the downlink integrated signal, and a second association relationship for characterizing a relationship between communication and sensing performances of the user device and the T-ISAC system parameters is constructed based on the integrated signal echo, in which the system parameters are system operating parameters required for constructing integrated waveforms; an OFDM frame structure design of the T-ISAC system is obtained based on the first association relationship and the second association relationship, and the T-ISAC system is controlled to generate integrated waveforms based on the OFDM frame structure design.

By applying the technical solutions of the present application, by constructing a sparse MIMO receiving and transmitting array model and an integrated OFDM transmission signal and reception echo model for the T-ISAC system, it is possible to establish the association relationships between communication and sensing performances and the OFDM frame structure and various parameters of the T-ISAC system. Moreover, considering the requirements of 6G application scenes and the association relationships, a method for calculating a feasible region of OFDM frame structure parameters is provided for the T-ISAC system, achieving the construction of integrated waveforms.

The technical solutions of the present application will be further described in detail below in connection with multiple embodiments.

### BRIEF DESCRIPTION OF THE DRAWINGS

The accompanying drawings, which form a part of the specification, illustrate the embodiments of the present application, and serve to explain the principle of the present application together with the description.

Referring to the accompanying drawings, the present application can be more clearly understood from the following detailed description, in which:

FIG. 1 shows a schematic diagram of a system architecture of the integrated sensing and communication waveform generation provided by an embodiment of the present application;

FIG. 2 shows a schematic diagram of the architecture of the T-ISAC system provided by an embodiment of the present application;

FIG. 3 shows a schematic flowchart of a waveform design method provided by an embodiment of the present application;

FIG. 4 shows a schematic diagram of the structure of an electronic device provided by an embodiment of the present application;

FIG. 5 shows a schematic diagram of the structure of an electronic device provided by an embodiment of the present application; and

FIG. 6 shows a schematic diagram of a storage medium provided by an embodiment of the present application.

### DETAILED DESCRIPTION

Various exemplary embodiments of the present application will now be described in detail with reference to the accompanying drawings. It should be noted that unless otherwise specified, the relative arrangement, numerical expressions, and numerical values of the components and steps described in these embodiments do not limit the scope of the present application.

At the same time, it should be understood that for ease of description, the sizes of various parts shown in the drawings are not drawn according to the actual proportional relationships.

Actually, the following description of at least one exemplary embodiment is merely illustrative, and should not be construed as any limitation to the present application and its application or use.

The techniques, methods and devices known to those skilled in the related art may not be discussed in detail, but in appropriate cases, such techniques, methods and devices should be considered as part of the specification.

It should be noted that similar signs and letters represent similar items in the following figures. Therefore, once an item is defined in one figure, it does not need to be further discussed in subsequent figures.

In addition, the technical solutions can be combined with each other between the various embodiments of the present application, but based on the fact that they can be achieved by those skilled in the art. When the combination of technical solutions makes the technical solutions contradict to each other or is impossible to implement, it should be considered that this combination of technical solutions does not exist and is not within the scope of protection claimed by the present application.

It should be noted that all directional indications (such as upper, lower, left, right, front, rear, etc.) in the embodiments of the present application are only used to explain the relative positional relationship, movement and the like between the components in a specific posture (such as that shown in the accompanying drawings). If the specific posture changes, the directional indications will also change accordingly.

The integrated sensing and communication waveform generation method according to an exemplary embodiment of the present application will be described below in connection with FIGS. 1-3. It should be noted that the following application scenes are only shown for the purpose of facilitating understanding the spirit and principle of the present application, and the embodiments of the present application are not limited in any way in this regard. On the contrary, the embodiments of the present application can be applied to any suitable scenes.

Further, the present application also proposes an integrated sensing and communication waveform generation method and device, an electronic device, and a medium.

FIG. 1 shows a schematic flowchart of an integrated sensing and communication waveform generation method according to an embodiment of the present application. As shown in FIG. 1, this method is applied to a T-ISAC system including a sparse MIMO linear array, and includes steps S101-S103.

S101: acquiring a downlink integrated signal received by a user device and acquiring an integrated signal echo received by the T-ISAC system during a communication process between the T-ISAC system and the user device implemented through the sparse MIMO linear array.

In an implementation, the T-ISAC system in the embodiment of the present application can adopt a MIMO linear array that does not share transmission and reception. The antenna spacing is set in a sparse transmission and compact reception mode to form a larger virtual aperture and achieve smaller angle resolution, thus achieving the goal of overcoming greater path loss than terahertz (THz) and increasing the radar operating distance of the T-ISAC system.

As an example, the feature of antenna spacing setting in the MIMO linear array proposed in the embodiment of the present application is that the antenna spacing of a compact receiving uniform linear array composed of NRx antennas is taken as half of the wavelength, that is,

$$\\ {d}_{Rx} = \frac{λ}{2} ,$$

and the antenna spacing of a sparse transmitting uniform linear array composed of N_{Tx} antennas is taken as the product of the receiving antenna spacing and the number of receiving antennas, that is,

$$\\ {d}_{Tx} = {N}_{Rx} {d}_{Rx} = {N}_{Rx} \frac{λ}{2} .$$

In an implementation, the T-ISAC system can transmit integrated MIMO-OFDM signals, acquiring sensing information through echoes, and achieve downlink communication with the user device.

As an example, one frame of the integrated MIMO-OFDM signal proposed in the embodiment of the present application consists of multiple OFDM symbols.

In an implementation, the T-ISAC system proposed in the embodiment of the present application can adopt a time division duplexing (TDD) system using the complete transmission and reception protocol. The integrated signal reception can be divided into three parts according to the types of received signals, namely, an uplink integrated signal received by the T-ISAC system from the user device, a downlink integrated signal received by the user device, and an integrated signal echo received by the T-ISAC system, respectively.

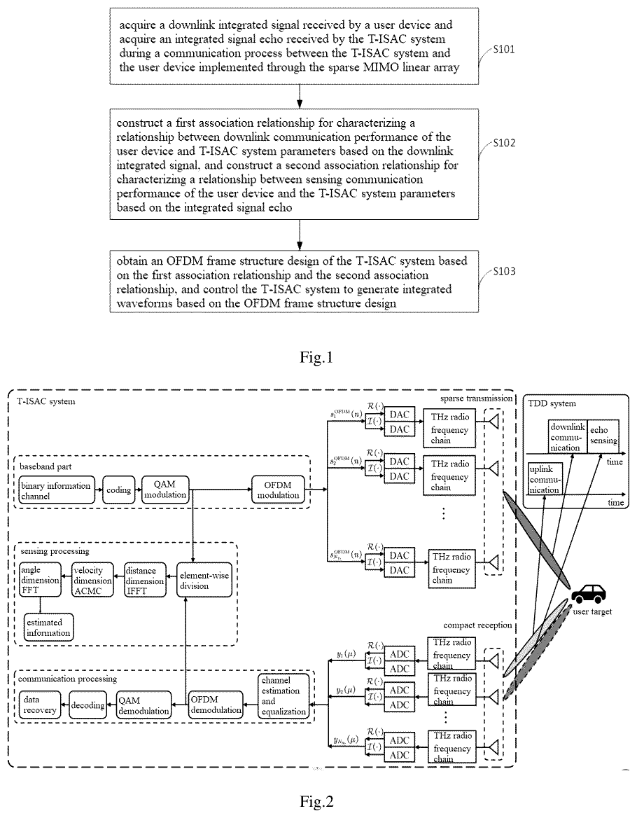

In a first aspect, for the uplink integrated signal:
it can be seen from FIG. 2 that the T-ISAC system can use the first frame in a continuous time for uplink communication; as an example, the T-ISAC system end receives the uplink communication signal transmitted by the user device, and after communication processing steps such as channel estimation, channel equalization, OFDM demodulation, QAM demodulation and the like in sequence, the T-ISAC system recovers communication information carried by the uplink signal, and realizes uplink communication from the user to the T-ISAC system.

In a second aspect, for the downlink integrated signal:
it can be seen from FIG. 2 that the T-ISAC system can use the second frame in the continuous time for downlink communication; as an example, the user device receives the integrated signal transmitted by the T-ISAC system, and after communication processing steps such as frequency and time synchronization, channel estimation, channel equalization, OFDM demodulation, QAM demodulation and the like in sequence, the user device recovers communication information carried by the integrated signal, and realizes downlink communication from the T-ISAC system to the user device.

Further, in the embodiment of the present application, one radio frame of the downlink integrated signal consists of a total of N_{sym} OFDM symbols, which is expressed as:

$$\\ \begin{matrix}\tilde{s} ( t ) = {[ {\tilde{s}}_{1} ( t ) , … , {\tilde{s}}_{i} ( t ) , … , {\tilde{s}}_{{N}_{Tx}} ( t ) ]}^{T} \\ = {W}_{Tx} {s}_{OFDM} ( t ) {e}^{j 2 {πf}_{c} t} \\ = {{\sum }^{{N}_{sym} - 1}}_{m = 0} {{\sum }^{{N}_{c} - 1}}_{n = 0} {A}_{Tx} ( {mN}_{c} + n ) {e}^{j 2 π n Δ f ( t - {mT}_{sym} )} {e}^{j 2 {πf}_{c} t} rect ( \frac{t - {mT}_{sym} + {T}_{CP}}{{T}_{sym}} ) ;\end{matrix}$$

where w_{Tx}∈ [symbol] ^{N}^{_{Tx}}^{×1} is a beamforming vector for transmission, N_{c} is the number of subcarriers, A_{Tx}(mN_{c}+n) is the normalized complex modulation information carried in the m^{th} OFDM symbol on the n^{th} subcarrier,

$$Δ f = \frac{1}{{T}_{u}}$$

is the subcarrier spacing, Tᵤ and T_{CP} are the effective symbol length and cyclic prefix (CP) length respectively, T_{sym}=T_{CP}+Tᵤ is a complete OFDM symbol length, and rect(·) is a rectangular window function.

In a third aspect, for the integrated signal echo:
it can be seen from FIG. 2 that the T-ISAC system can use the third frame in the continuous time for echo sensing; as an example, the T-ISAC system end receives broadband echo signals generated by the integrated signals after being reflected by the user device.

It can be understood that due to the large time-bandwidth product characteristic of THz integrated MIMO-OFDM signals, namely,

$${B}_{OFDM} {N}_{sym} {T}_{sym} ≪̸︀ \frac{{c}_{0}}{2 \vert v \vert} ,$$

the time stretching/compression effect of the Doppler effect on the echo signals cannot be ignored. Therefore, the baseband echo signal after down conversion is:

$$r ( t ) = {[ {\tilde{r}}_{1} ( t ) , … , {\tilde{r}}_{l} ( t ) , … , {\tilde{r}}_{{N}_{Rx}} ( t ) ]}^{T} {e}^{- j 2 {π f}_{c} t} = {𝒶 a}_{Rx} ( θ ) {a}_{Tx}^{T} ( θ ) \tilde{s} ( t - 𝒯 ( t ) ) {e}^{- j 2 {π f}_{c} t} + \tilde{n} ( t ) {e}^{- j 2 {π f}_{c} t} = {𝒶 e}^{- j 2 {π f}_{c} t} {e}^{j 2 {π f}_{D} t} {a}_{Rx} ( θ ) {a}_{Tx}^{T} ( θ ) {w}_{Tx} {\sum }_{m = 0}^{{N}_{sym} - 1} {\sum }_{n = 0}^{{N}_{c} - 1} {A}_{Tx} ( {mN}_{c} + n ) {e}^{j 2π n Δ f ( t - {mT}_{sym} )} {e}^{j 2π n Δ f 𝒯} \cdot {e}^{j 2π n Δ f ( β - 1 ) t} rect ( \frac{β t - 𝒯 - {mT}_{sym} + {T}_{CP}}{{T}_{sym}} ) + n ( t ) ;$$

where a is a complex channel gain including THz path loss and user target reflection coefficient,

$${a}_{TX} ( θ ) = {[ 1 , {e}^{j \frac{2 π}{λ} {d}_{Tx} sin θ} , … , {e}^{j \frac{2 π}{λ} ( {N}_{Tx} - 1 ) {d}_{Tx} sin θ} ]}^{T}$$

$$and$$

$${a}_{Rx} ( θ ) = {[ 1 , {e}^{j \frac{2 π}{λ} {d}_{Rx} sin θ} , … , {e}^{j \frac{2 π}{λ} ( {N}_{Rx} - 1 ) {d}_{Rx} sin θ} ]}^{T}$$

are steering vectors of the transmitting array and the receiving array respectively, θ is an azimuth angle of the user target,

$$T = \frac{2 R}{{c}_{0}}$$

is a bidirectional propagation delay, R is a distance between the user target and the T-ISAC system,

$${f}_{D} = {f}_{c} \frac{2 v}{{c}_{0}}$$

is the Doppler frequency shift, υ is a relative radial velocity of the user target,

$$β = 1 + \frac{2 v}{{c}_{0}}$$

is the Doppler stretching/compression factor, and n(t) is a baseband additive white Gaussian noise (AWGN).

In addition, after sensing processing steps such as two-dimensional fast Fourier transform (2D-FFT) and all-cell migration compensation (ACMC), the present application can also obtain the sensing information of the user target, including the distance from the T-ISAC system to the user target, and a radial moving velocity and azimuth angle of the user target relative to the T-ISAC system, achieving the sensing of the user target by the T-ISAC system. The sensing information is used to assist in communication alignment.

Further, after CP is removed, the T-ISAC system can also sample the above baseband echo signals at a sampling rate Fₛ=B_{OFDM} to obtain a discrete signal within each OFDM symbol time as follows:

$${y}^{( μ , m )} = \overline{a} {e}^{{j 2 π f}_{0} {mT}_{sym}} {e}^{{j 2 π f}_{0} \frac{μ}{{N}_{c}} {T}_{a}} {a}_{Rx} ( θ ) {a}_{Tx}^{T} ( θ ) {W}_{Tx} {\sum }_{n = 0}^{{N}_{c} - 1} {A}_{Tx} ( {mN}_{c} + n ) \cdot {e}^{j 2 π n \frac{μ}{{N}_{c}}} {e}^{- j 2 πΔ fT} {e}^{j 2 π \frac{2 v}{{c}_{0}} m ( 1 + α )} + {n}^{( μ , m )} ;$$

where ā=ae^{-j2πf}^{ₑ}^{τ} is the normalization constant,

$$α = \frac{{T}_{CP}}{{T}_{u}}$$

is the ratio of CP to the effective symbol length, and μ=0, 1, . . . , N_{c}−1 is the sampling point number.

Further, in the embodiment of the present application, the above discrete echo signals can go through the sensing processing steps such as 2D-FFT and ACMC to acquire the sensing information of the user device, including the distance from the T-ISAC system to the user device, and the radial moving velocity and azimuth angle of the user device relative to the T-ISAC system, achieving the sensing of the user device by the T-ISAC system. The sensing information is used to assist in communication alignment.

S102: constructing a first association relationship for characterizing a relationship between downlink communication performance of the user device and T-ISAC system parameters based on the downlink integrated signal, and constructing a second association relationship for characterizing a relationship between communication and sensing performances of the user device and the T-ISAC system parameters based on the integrated signal echo, in which the system parameters are system operating parameters required for constructing integrated waveforms.

In an implementation, in the embodiment of the present application, a first association relationship between an effective transmission rate, a power spectral density ratio, a bit error rate, a communication signal-to-noise ratio, and other indicators of the downlink transmission channel can be analyzed and derived based on the downlink integrated signal received by the user device, so as to characterize the communication performance of the user device.

In a first aspect, for the effective transmission rate:
factors such as the number of spatial data streams and the additional overhead caused by CP, time synchronization, and redundant coding are considered in the embodiment of the present application, obtaining the first sub association relationship between the effective transmission rate actually experienced by the user device and the T-ISAC system parameters as follows:

$${ℛ}_{eff}^{OFDM} = {N}_{Tx} {B}_{OFDM} ( 1 - \frac{{n}_{sym}}{{N}_{sym}} ) \frac{{ηlog}_{2} M}{1 + α} ;$$

where B_{OFDM}=N_{c}Δf is the bandwidth of the integrated signal,

$${n}_{sym} = \frac{{T}_{t}}{{T}_{c}}$$

is the number of synchronization symbols, T_{f}=N_{sym} T_{sym} is the total frame length of one frame of the integrated signal,

$${T}_{c} = \frac{1}{{f}_{D , max}}$$

is the coherence time of the channel,

$$α = \frac{{T}_{CP}}{{T}_{u}}$$

is the ratio of CP to the effective symbol length, η is the code rate of redundant coding, and M is the modulation order.

In a second aspect, for the ratio of symbol energy to AWGN power spectral density:
the embodiment of the present application considers multiple antenna users, and after completion of steps such as frequency and time synchronization, channel estimation and channel equalization, frequency response estimation of the communication channel can be achieved; therefore, the second sub association relationship between the ratio of symbol energy to AWGN power spectral density and the T-ISAC system parameters can be calculated as follows:

$${( \frac{{E}_{s}}{{N}_{0}} )}_{OFDM} = \frac{{P}_{Tx}}{{N}_{Tx} {N}_{Rx}^{UE} {N}_{c} {N}_{0}} {\sum }_{n = 0}^{{N}_{c} - 1} {\sum }_{l = 1}^{{N}_{Rx}^{UE}} {\sum }_{i = 1}^{{N}_{Tx}} {\vert {H}_{i , l}^{OFDM} ( n ) \vert}^{2} ;$$

where P_{Tx} is the transmission power of each transmitting antenna in the T-ISAC system,

$${N}_{Rx}^{UE}$$

is the number of receiving antennas at the user end, N₀ is the unilateral power spectral density of AWGN, and

$${H}_{i , l}^{OFDM} ( n )$$

is the channel frequency response estimation of the n^{th} subcarrier on the i_lₜₕ subchannel.

In a third aspect, for the bit error rate:
the embodiment of the present application considers using multiple quadrature amplitude modulation (MQAM), and the third sub association relationship between the bit error rate and the T-ISAC system parameters can be approximately obtained by combining

$${( \frac{{E}_{s}}{{N}_{0}} )}_{OFDM}$$

with the MQAM bit error rate theory expression:

$${BER}_{OFDM}^{MQAM} \approx 2 ( \frac{\sqrt{M} - 1}{\sqrt{M} {log}_{2} \sqrt{M}} ) Q ( \sqrt{\frac{3 {( {E}_{s} / {N}_{0} )}_{OFDM}}{M - 1}} ) ;$$

where Q(·) is the right truncation function of the standard normal distribution.

In a fourth aspect, for the communication signal-to-noise ratio:
based on the free path loss model and considering the molecular absorption loss and molecular absorption noise caused by THz molecular absorption effect, the fourth sub association relationship between the communication signal-to-noise ratio directly related to the communication distance and the T-ISAC system parameters is as follows:

$${SNR}_{com}^{OFDM} = \frac{{N}_{Tx} {P}_{Tx} {G}_{Tx} {N}_{Rx}^{UE} {G}_{Rx}^{UE} {G}_{c} {λ}^{2}}{{( 4 π )}^{2} {P}_{N}^{com} {N}_{Fig}^{UE} {R}_{com}^{2} {L}_{mol}^{com}} ;$$

where G_{Tx} is the transmission gain of each transmitting antenna in the T-ISAC system,

$${G}_{Rx}^{UE}$$

is the reception gain of each receiving antenna at the user end, Gₑ is the redundancy coding gain,

$${P}_{N}^{com} = {k}_{B} {\int }_{{B}_{OFDM}} ( {T}_{sys} + {T}_{mol}^{com} ( f , {R}_{com} ) ) df$$

is the total noise power of the system, k_{B} is the Boltzmann is the constant, T_{sys} is the AWGN temperature (K) of the system,

$${T}_{mol}^{com} ( f , {R}_{com} ) = {T}_{0} ( 1 - \frac{1}{{L}_{mol}^{com} ( f , {R}_{com} )} )$$

is the molecular absorption noise temperature (K), T₀ is the reference temperature (K),

$${L}_{mol}^{com} ( f , {R}_{com} ) [ dB ] = γ ( f ) {R}_{com}$$

is the molecular absorption loss (dB) in communication, γ(f) is the atmospheric attenuation coefficient (dB/m) related to the frequency f, R_{com} is the communication distance (m), and

$${N}_{Fig}^{UE}$$

is the reception noise coefficient at the user end.

In another implementation, in the embodiment of the present application, the second association relationship between the distance/velocity/angle resolution, the maximum sensing distance/velocity, the sensing signal-to-noise ratio, and other indicators can be analyzed and derived based on the integrated signal echo received by the T-ISAC system, so as to characterize the communication and sensing performances of the user device.

In a fifth aspect, for the distance indicator:
in the embodiment of the present application, IFFT transformation is performed on the delay inclusion term in the integrated echo signal to obtain a distance estimation value, and then obtain the fifth sub association relationship between the distance indicator of the user device and the T-ISAC system:

$$Δ {R}_{OFDM} = \frac{{c}_{0}}{2 {N}_{c} Δ f} = \frac{{c}_{0}}{2 {B}_{OFDM}} .$$

Further, in order to avoid introducing inter symbol interference in echo signal processing, the maximum permitted distance is calculated as:

$${R}_{max , toler}^{OFDM} = {N}_{CP} Δ {R}_{OFDM} = \frac{{c}_{0} {T}_{CP}}{2} .$$

Further, in order to avoid the problem of distance ambiguity in distance estimation, the maximum unambiguous distance is calculated as:

$${R}_{max , unamb}^{OFDM} = {N}_{c} Δ {R}_{OFDM} = \frac{{c}_{0} {T}_{u}}{2} .$$

In a sixth aspect, for the velocity indicator:
in the embodiment of the present application, ACMC transformation is performed on the Doppler inclusion term in the integrated echo signal to obtain a relative radial velocity estimation value, and then obtain the sixth sub association relationship between the moving velocity indicator and the T-ISAC system:

$$Δ {v}_{OFDM} = \frac{{c}_{0}}{2 {f}_{c} {T}_{f}} .$$

Further, the value of subcarrier spacing needs to be reasonably selected to overcome the inter carrier interference caused by the Doppler effect, usually being 10 times or more of the maximum Doppler frequency shift, that is, Δf≥10f_{D,max}, so as to obtain the maximum permitted relative radial velocity:

$${v}_{max , toler}^{OFDM} = \pm \frac{{c}_{0} Δ f}{20 {f}_{c}} .$$

Further, in order to avoid the problem of velocity ambiguity in velocity estimation, the maximum unambiguous relative radial velocity is calculated as follows:

$${v}_{max , unamb}^{OFDM} = \pm \frac{1}{2} {N}_{sym} Δ {v}_{OFDM} = \pm \frac{{c}_{0}}{4 {f}_{c} {T}_{sym}} .$$

In a seventh aspect, for the velocity indicator:
in the embodiment of the present application, FFT transformation is performed on the azimuth angle inclusion term in the integrated echo signal to obtain an azimuth angle estimation value, and then obtain the seventh sub association relationship between the relative angle indicator and the T-ISAC system as follows:

$$Δθ = \frac{180 °}{π} arcsin \frac{2}{{N}_{Tx} {N}_{Rx}} .$$

In an eighth aspect, for the total system loss:
for the integrated echo signals, the embodiment of the present application considers various system losses in the actual T-ISAC system, making the characterization of communication and sensing performances more accurate and complete. According to the bidirectional propagation characteristic of the echo signals, the molecular absorption loss (dB) experienced is:

$${L}_{mol}^{sen} ( f , {R}_{rad} ) [ dB ] = 2 γ ( f ) {R}_{rad} ;$$

where R_{rad} is the operating distance (m) of the T-ISAC system.

Further, the beam shape loss in the azimuth angle dimension under dense sampling is:

$${L}_{b} = {( \frac{1}{{θ}_{3 dB}} {\int }_{- \frac{π}{2}}^{\frac{π}{2}} {f}^{4} ( θ ) d θ )}^{- 1} ;$$

where

$${θ}_{3 dB} = \frac{2 \sqrt{2}}{π} \cdot \frac{λ}{{N}_{Tx} {d}_{Tx}} = \frac{4 \sqrt{2}}{π {N}_{Tx} {N}_{Rx}}$$

is the half power beamwidth of the sparse MIMO array, and f(θ) is the unidirectional voltage shape function that describes different beam shapes.

Further, the array scanning loss Lₛ generated when sensing the position of the user device can be calculated using the arrayscanloss function in the Matlab2022a radar toolbox, and its magnitude is related to the detection probability, false alarm probability, number of symbols contained in the echoes received by the T-ISAC system, azimuth angle sensing range, and the fluctuation model of the user device.

Further, considering using cell averaging-constant false alarm rate (CA-CFAR) during the sensing process, the constant false alarm loss (dB) generated can be approximately calculated as:

$${L}_{CFAR} [ dB ] \approx \frac{{P}_{fa}^{- 1 / L} - 1}{ln {P}_{fa}^{- 1 / L}} ;$$

where P_{fa} is the false alarm probability, and L is the number of reference cells used by the constant false alarm detector.

Further, by superposing all the losses mentioned above, the eighth sub association relationship between the total system loss during the sensing process and the T-ISAC system is obtained:

$${L}_{total}^{sen} = {L}_{mol}^{sen} {L}_{b} {L}_{s} {L}_{CFAR} .$$

In a ninth aspect, for the sensing signal-to-noise ratio:
the embodiment of the present application is based on the classical radar operating distance equation, considering the virtual aperture gain formed by the sparse MIMO array, the molecular absorption noise generated by the THz molecular absorption effect, and the total system loss. A ninth sub association relationship between the sensing signal-to-noise ratio directly related to the operating distance and the T-ISAC system is:

$${SNR}_{sen}^{OFDM} = \frac{{N}_{Tx}^{2} {N}_{Rx} {P}_{Tx} {G}_{Tx} {G}_{Rx}^{ISAC} {G}_{p}^{OFDM} {σ}_{RCS} {λ}^{2}}{{( 4 π )}^{3} {P}_{N}^{sen} {N}_{Fig}^{ISAC} {R}_{rad}^{4} {L}_{total}^{sen}} ;$$

where

$${G}_{Rx}^{ISAC}$$

is the receiving antenna in the T-ISAC system,

$${G}_{p}^{OFDM} = {N}_{c} {N}_{sym}$$

is the processing gain generated by FFT and ACMC algorithms in the echo processing of the integrated OFDM signal, σ_{RCS} is the radar reflection cross-sectional area of the user device,

$${N}_{Fig}^{ISAC}$$

is the receiving noise coefficient of the T-ISAC system,

$${P}_{N}^{sen} = {k}_{B} {\int }_{{B}_{OFDM}} ( {T}_{sys} + {T}_{mol}^{sen} ( f , {R}_{rad} ) ) df$$

is the is the total noise power of the system, and

$${T}_{mol}^{sen} ( f , {R}_{rad} ) = {T}_{0} ( 1 - \frac{1}{{L}_{mol}^{sen} ( f , {R}_{rad} )} )$$

is the molecular absorption noise temperature (K).

S103: obtaining an OFDM frame structure design of the T-ISAC system based on the first association relationship and the second association relationship, and controlling the T-ISAC system to generate integrated waveforms based on the OFDM frame structure design.

In an implementation, the basic requirements of OFDM frame structure design, the characterization results of communication and sensing performances, and the requirements of 6G application scenes for communication and sensing performances can be combined in the embodiment of the present application to construct a set of inequalities and calculate the feasible range of OFDM frame structure parameters.

As an example, according to the basic requirements of OFDM design, its frame structure parameters need to meet:

$$\{ \begin{matrix}{T}_{CP} > {τ}_{RMS} \\ Δ f < {B}_{c} \\ {T}_{u} ≪ {T}_{c}\end{matrix} {⟹}^{simplify} \{ \begin{matrix}Δ f < \frac{α}{{τ}_{RMS}} \\ Δ f < {B}_{c} \\ Δ f ≫ {T}_{c}^{- 1}\end{matrix} ;$$

where τ_{RMS} is the root mean square delay extension of the channel, and

$${B}_{c} = \frac{2 π}{{τ}_{RMS}}$$

is the coherent bandwidth of the channel.

Further, in terms of sensing, the first association relationship, the second association relationship and the requirements of 6G application scenes for communication and sensing performances can be combined to construct the frame structure parameters of OFDM respectively, which for example include:

$$\{ \begin{matrix}Δ {R}_{OFDM} ⩽ Δ {R}_{req} \\ Δ {v}_{OFDM} ⩽ Δ {v}_{req} \\ \text{?} ⩾ {R}_{req} \\ {R}_{max , unamb}^{OFDM} ⩾ {R}_{req} \\ \vert v \text{?} ⩾ {\vert v \vert}_{req} \\ \vert v \text{?} ⩾ {\vert v \vert}_{req} \\ {T}_{f} ⩽ 0.02\end{matrix} {⟹}^{\begin{matrix}brought into step \\ S 5 to obtain \\ parameterization \\ results\end{matrix}} \{ \begin{matrix}\frac{{c}_{0}}{2 {N}_{c} Δ f} ⩽ Δ {R}_{req} \\ \frac{{c}_{0}}{2 {f}_{c} {N}_{sym} {T}_{sym}} ⩽ Δ {v}_{req} \\ \frac{{c}_{0}}{2} {T}_{CP} ⩾ {R}_{req} \\ \frac{{c}_{0}}{2} {T}_{n} ⩾ {R}_{req} \\ \frac{{c}_{0} Δ f}{20 {f}_{c}} ⩾ {\vert v \vert}_{req} \\ \frac{{c}_{0}}{4 {f}_{c} {T}_{sym}} ⩾ {\vert v \vert}_{req} \\ {N}_{sym} {T}_{sym} ⩽ 0.02\end{matrix} {⟹}^{simplify} \{ \begin{matrix}{N}_{c} Δ f ⩾ \frac{{c}_{0}}{Δ {R}_{req}} \\ \frac{{N}_{sym}}{Δ f} ⩾ \frac{{c}_{0}}{2 ( 1 + α ) {f}_{c} Δ {v}_{req}} \\ Δ f ⩽ \frac{α {c}_{0}}{2 {R}_{req}} \\ Δ f ⩾ \frac{20 {f}_{c} {\vert v \vert}_{req}}{{c}_{0}} \\ \frac{{N}_{sym}}{Δ f} ⩽ \frac{0.02}{1 + α}\end{matrix} ;$$

$$\text{?} \text{indicates text missing or illegible when filed}$$

where ΔR_{req}, Δυ_{req}, R_{req} and |υ|_{req} are performance requirements of 6G application scenes for distance resolution, velocity resolution, sensing distance, and relative radial sensing velocity respectively, and T_{f}≤0.02 indicates that the OFDM frame length in typical applications should not be too long, generally not exceeding 20 ms.

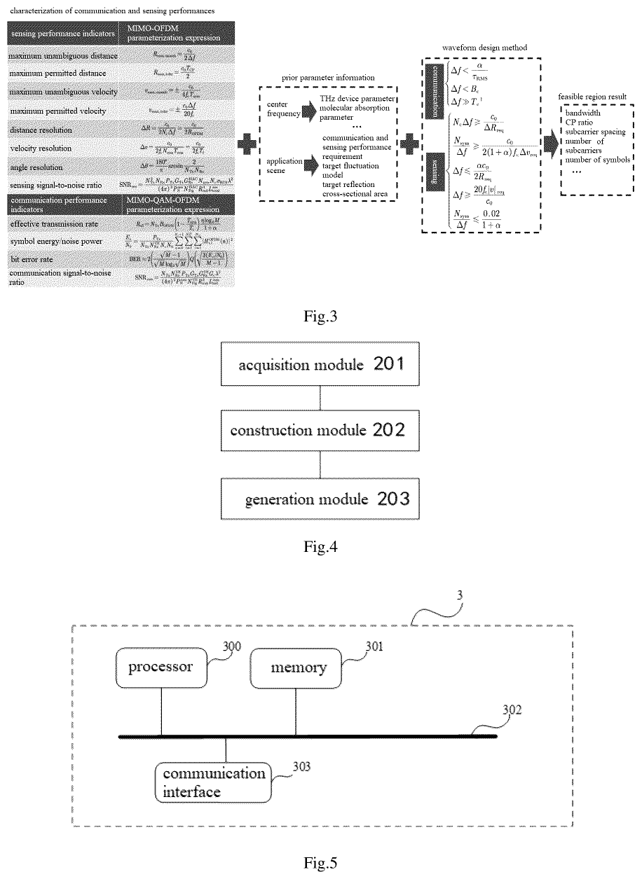

It can be understood that as shown in FIG. 3, according to the requirements of a certain 6G application scene, parameter values that meet the range can be determined in the embodiment of the present application, and the parameter values that meet the requirements are brought into the first association relationship and the second association relationship (the association relationships are used to characterize the relationship between the communication and sensing performances and the system operating parameters required to construct the integrated waveforms, and the system parameters are the system operating parameters required to construct the integrated waveforms) to obtain appropriate system operating parameters required to construct the integrated waveforms (such as the subcarrier spacing, the number of subcarriers, the cyclic prefix ratio, and the number of symbols).

By applying the technical solutions of the present application, by constructing a sparse MIMO receiving and transmitting array model and an integrated OFDM transmission signal and reception echo model for the T-ISAC system, it is possible to establish the association relationships between communication and sensing performances and the OFDM frame structure and various parameters of the T-ISAC system. Moreover, considering the requirements of 6G application scenes and the association relationships, a method for calculating a feasible region of OFDM frame structure parameters is provided for the T-ISAC system, achieving the construction of integrated waveforms.

Optionally, in another embodiment based on the above method of the present application, the acquiring an integrated signal echo received by the T-ISAC system includes:
acquiring the integrated signal echo emitted after being reflected by the user device and received by the T-ISAC system.

Optionally, in another embodiment based on the above method of the present application, the constructing a first association relationship for characterizing a relationship between downlink communication performance of the user device and T-ISAC system parameters based on the downlink integrated signal includes:
determining a first sub association relationship for reflecting a relationship between an effective transmission rate of a downlink transmission channel and the T-ISAC system parameters, a second sub association relationship between a power spectral density ratio of the downlink transmission channel and the T-ISAC system parameters, a third sub association relationship between a bit error rate of the downlink transmission channel and the T-ISAC system parameters, and a fourth sub association relationship between a communication signal-to-noise ratio of the downlink transmission channel and the T-ISAC system parameters based on communication information carried by the downlink integrated signal; and
taking the first sub association relationship, the second sub association relationship, the third sub association relationship and the fourth sub association relationship as the first association relationship.

Optionally, in another embodiment based on the above method of the present application, the constructing a second association relationship for characterizing a relationship between communication and sensing performances of the user device and the T-ISAC system parameters based on the integrated signal echo includes:
determining a fifth sub association relationship for reflecting a relationship between a distance indicator of the user device and the T-ISAC system, a sixth sub association relationship between a moving velocity indicator of the user device and the T-ISAC system, a seventh sub association relationship between a relative angle indicator of the user device and the T-ISAC system, and an eighth sub association relationship between a total system loss and the T-ISAC system, and a ninth sub association relationship between a sensing signal-to-noise ratio and the T-ISAC system based on communication information carried by the integrated signal echo; and
taking the fifth sub association relationship, the sixth sub association relationship, the seventh sub association relationship the eighth sub association relationship and the ninth sub association relationship as the second association relationship.

Optionally, in another embodiment based on the above method of the present application, the obtaining an OFDM frame structure design of the T-ISAC system based on the first association relationship and the second association relationship includes:
acquiring 6G application scene requirements, and determining a subcarrier spacing, the number of subcarriers, a cyclic prefix ratio, and the number of symbols of the T-ISAC system based on the 6G application scene requirements, the first association relationship, and the second association relationship; and
determining the OFDM frame structure design based on the subcarrier spacing, the number of subcarriers, the cyclic prefix ratio, and the number of symbols of the T-ISAC system.

Optionally, in another embodiment based on the above method of the present application, the determining a subcarrier spacing, the number of subcarriers, a cyclic prefix ratio, and the number of symbols of the T-ISAC system based on the 6G application scene requirements, the first association relationship, and the second association relationship includes:
calculating a parameter feasible region of the OFDM frame structure based on the first association relationship and the second association relationship under the condition of meeting the 6G application scene requirements, in which the parameter feasible region includes the subcarrier spacing, the number of subcarriers, the cyclic prefix ratio, and the number of symbols.

In another embodiment of the present application, as shown in FIG. 4, the present application also provides an integrated sensing and communication waveform generation device, which is applied to a T-ISAC system including a MIMO linear array, and which includes:
an acquisition module 201, which is configured to acquire a downlink integrated signal received by a user device and acquire an integrated signal echo received by the T-ISAC system during a communication process between the T-ISAC system and the user device implemented through the MIMO linear array;
a construction module 202, which is configured to construct a first association relationship for characterizing a relationship between downlink communication performance of the user device and T-ISAC system parameters based on the downlink integrated signal, and construct a second association relationship for characterizing a relationship between communication and sensing performances of the user device and the T-ISAC system parameters based on the integrated signal echo, in which the system parameters are system operating parameters required for constructing integrated waveforms; and
a generation module 203, which is configured to obtain an OFDM frame structure design of the T-ISAC system based on the first association relationship and the second association relationship, and control the T-ISAC system to generate integrated waveforms based on the OFDM frame structure design

By applying the technical solutions of the present application, by constructing a sparse MIMO receiving and transmitting array model and an integrated OFDM transmission signal and reception echo model for the T-ISAC system, it is possible to establish the association relationships between communication and sensing performances and the OFDM frame structure and various parameters of the T-ISAC system. Moreover, considering the requirements of 6G application scenes and the association relationships, a method for calculating a feasible region of OFDM frame structure parameters is provided for the T-ISAC system, achieving the construction of integrated waveforms.

In another embodiment of the present application, the construction module 202 is configured to:
acquire the integrated signal echo emitted after being reflected by the user device and received by the T-ISAC system.

In another embodiment of the present application, the construction module 202 is configured to:
determine a first sub association relationship for reflecting a relationship between an effective transmission rate of a downlink transmission channel and the T-ISAC system parameters, a second sub association relationship between a power spectral density ratio of the downlink transmission channel and the T-ISAC system parameters, a third sub association relationship between a bit error rate of the downlink transmission channel and the T-ISAC system parameters, and a fourth sub association relationship between a communication signal-to-noise ratio of the downlink transmission channel and the T-ISAC system parameters based on communication information carried by the downlink integrated signal; and
take the first sub association relationship, the second sub association relationship, the third sub association relationship and the fourth sub association relationship as the first association relationship.

In another embodiment of the present application, the construction module 202 is configured to:
determine a fifth sub association relationship for reflecting a relationship between a distance indicator of the user device and the T-ISAC system, a sixth sub association relationship between a moving velocity indicator of the user device and the T-ISAC system, a seventh sub association relationship between a relative angle indicator of the user device and the T-ISAC system, an eighth sub association relationship between a total system loss and the T-ISAC system, and a ninth sub association relationship between a sensing signal-to-noise ratio and the T-ISAC system based on communication information carried by the integrated signal echo; and
take the fifth sub association relationship, the sixth sub association relationship, the seventh sub association relationship, the eighth sub association relationship and the ninth sub association relationship as the second association relationship.

In another embodiment of the present application, the construction module 202 is configured to:
acquire 6G application scene requirements, and determine a subcarrier spacing, the number of subcarriers, a cyclic prefix ratio, and the number of symbols of the T-ISAC system based on the 6G application scene requirements, the first association relationship, and the second association relationship; and
determine the OFDM frame structure design based on the subcarrier spacing, the number of subcarriers, the cyclic prefix ratio, and the number of symbols of the T-ISAC system.

In another embodiment of the present application, the construction module 202 is configured to:
calculate a parameter feasible region of the OFDM frame structure based on the first association relationship and the second association relationship under the condition of meeting the 6G application scene requirements, in which the parameter feasible region includes the subcarrier spacing, the number of subcarriers, the cyclic prefix ratio, and the number of symbols.

Embodiments of the present application also provide an electronic device to perform the integrated sensing and communication waveform generation method described above. Reference is made to FIG. 5, which shows a schematic diagram of the electronic device provided by some embodiments of the present application. As shown in FIG. 5, the electronic device 3 includes a processor 300, a memory 301, a bus 302, and a communication interface 303. The processor 300, the communication interface 303, and the memory 301 are connected through the bus 302; and the memory 301 stores a computer program that can be run on the processor 300. When the processor 300 runs the computer program, the above integrated sensing and communication waveform generation method provided in any of the above embodiments of the present application is performed.

The memory 301 may include a high-speed random-access memory (RAM), and may also include a non-volatile memory, such as at least one magnetic disk storage. The communication connection between this device network element and at least one other network element is realized through at least one communication interface 303 (which may be wired or wireless), and the Internet, wide area network, local area network, metropolitan area network and the like can be used.

The bus 302 can be an ISA bus, a PCI bus, or an EISA bus, etc. The bus can be divided into address bus, data bus, control bus, etc. The memory 301 is used to store programs, and the processor 300 executes the program after receiving an execution instruction. The integrated sensing and communication waveform generation method provided in any of the above embodiments of the present application can be applied to the processor 300 or implemented by the processor 300.

The processor 300 may be an integrated circuit chip with signal processing capabilities. In the implementation process, each step of the above method can be completed through integrated logic circuits of hardware in the processor 300 or through software instructions. The processor 300 mentioned above can be a general-purpose processor, including a Central Processing Unit (CPU), a Network Processor (NP), etc.; it can also be a digital signal processor (DSP), an application specific integrated circuit (ASIC), a field programmable gate array (FPGA) or other programmable logic devices, discrete gates or transistor logic devices, or discrete hardware components. The methods, steps, and logical diagrams disclosed in the embodiments of the present application can be implemented or executed. The general-purpose processor can be a microprocessor, or the processor can be any conventional processor, etc. The steps of the method disclosed in the embodiments of the present application can be directly executed by a hardware decoding processor, or executed by a combination of hardware and software modules in the decoding processor. The software modules can be located in mature storage media in the art, such as random-access memory, flash memory, read-only memory, programmable read-only memory, or electrically erasable programmable memory, register, etc. The storage medium is located in the memory 301, and the processor 300 reads the information from the memory 301 and completes the steps of the above method in conjunction with its hardware.

The electronic device provided in the embodiment of the present application is based on the same inventive concept as the integrated sensing and communication waveform generation method provided in the embodiment of the present application, and has the same advantageous effects as the methods adopted, operated or implemented by it.

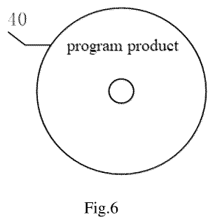

Embodiments of the present application also provide a computer-readable storage medium corresponding to the integrated sensing and communication waveform generation method provided in the above embodiments. Reference is made to FIG. 6, which shows that the computer-readable storage medium is an optical disc 40, on which a computer program (i.e., a program product) is stored. When the computer program is run by the processor, it will execute the integrated sensing and communication waveform generation method provided in any of the above embodiments.

It should be noted that examples of the computer-readable storage media may also include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory, or other optical or magnetic storage media, which will not be listed exhaustively herein.

The computer-readable storage medium provided in the above embodiment of the present application is based on the same inventive concept as the integrated sensing and communication waveform generation method provided in the embodiment of the present application, and has the same advantageous effects as the method adopted, operated or implemented by the application program stored therein.

It should be noted that:

In the specification provided herein, a large number of specific details are explained. However, it can be understood that the embodiments of the present application can be practiced without these specific details. In some examples, well-known structures and techniques are not shown in detail to avoid obscuring the understanding of the specification.

Similarly, it should be understood that in order to simplify the present application and assist in understanding one or more inventive aspects, in the above description of the exemplary embodiments of the present application, various features of the present application are sometimes grouped together into a single embodiment, figure, or description thereof. However, the disclosed method should not be interpreted as reflecting the following intension: the claimed application requires more features than those explicitly recorded in each claim. More precisely, as reflected in the following claims, the inventive aspects lie in having fewer features than all the features of the single embodiment disclosed earlier. Therefore, the claims that follow a specific embodiment are explicitly incorporated into this specific embodiment, where each claim itself serves as a separate embodiment of the present application.

In addition, it can be understood by those skilled in the art that although some embodiments described herein include certain features included in other embodiments rather than other features, the combination of features of different embodiments means that it is within the scope of the present application and forms different embodiments. For example, in the following claims, any one of the claimed embodiments can be used in any combination.

Described above are only preferred specific embodiments of the present application, but the scope of protection of the present application is not limited to this. Any changes or replacements that can be easily conceived by those skilled in the art within the technical scope disclosed by the present application should be covered within the scope of protection of the present application. Therefore, the scope of protection of the present application should be accorded with the scope of protection of the claims.

1. An integrated sensing and communication waveform generation method, which is applied to a T-ISAC system comprising a sparse MIMO linear array, and which comprises:
acquiring a downlink integrated signal received by a user device and acquiring an integrated signal echo received by the T-ISAC system during a communication process between the T-ISAC system and the user device implemented through the sparse MIMO linear array;
constructing a first association relationship for characterizing a relationship between downlink communication performance of the user device and T-ISAC system parameters based on the downlink integrated signal, and constructing a second association relationship for characterizing a relationship between communication and sensing performances of the user device and the T-ISAC system parameters based on the integrated signal echo, wherein the system parameters are system operating parameters required for constructing integrated waveforms; and
obtaining an OFDM frame structure design of the T-ISAC system based on the first association relationship and the second association relationship, and controlling the T-ISAC system to generate integrated waveforms based on the OFDM frame structure design.

2. The method according to claim 1, wherein the acquiring an integrated signal echo received by the T-ISAC system comprises:
acquiring the integrated signal echo emitted after being reflected by the user device and received by the T-ISAC system.

3. The method according to claim 1, wherein the constructing a first association relationship for characterizing a relationship between downlink communication performance of the user device and T-ISAC system parameters based on the downlink integrated signal comprises:
determining a first sub association relationship for reflecting a relationship between an effective transmission rate of a downlink transmission channel and the T-ISAC system parameters, a second sub association relationship between a power spectral density ratio of the downlink transmission channel and the T-ISAC system parameters, a third sub association relationship between a bit error rate of the downlink transmission channel and the T-ISAC system parameters, and a fourth sub association relationship between a communication signal-to-noise ratio of the downlink transmission channel and the T-ISAC system parameters based on communication information carried by the downlink integrated signal; and
taking the first sub association relationship, the second sub association relationship, the third sub association relationship and the fourth sub association relationship as the first association relationship.

4. The method according to claim 1, wherein the constructing a second association relationship for characterizing a relationship between communication and sensing performances of the user device and the T-ISAC system parameters based on the integrated signal echo comprises:
determining a fifth sub association relationship for reflecting a relationship between a distance indicator of the user device and the T-ISAC system, a sixth sub association relationship between a moving velocity indicator of the user device and the T-ISAC system, a seventh sub association relationship between a relative angle indicator of the user device and the T-ISAC system, an eighth sub association relationship between a total system loss and the T-ISAC system, and a ninth sub association relationship between a sensing signal-to-noise ratio and the T-ISAC system based on communication information carried by the integrated signal echo; and
taking the fifth sub association relationship, the sixth sub association relationship, the seventh sub association relationship, the eighth sub association relationship and the ninth sub association relationship as the second association relationship.

5. The method according to claim 1, wherein the obtaining an OFDM frame structure design of the T-ISAC system based on the first association relationship and the second association relationship comprises:
acquiring 6G application scene requirements, and determining a subcarrier spacing, the number of subcarriers, a cyclic prefix ratio, and the number of symbols of the T-ISAC system based on the 6G application scene requirements, the first association relationship, and the second association relationship; and
determining the OFDM frame structure design based on the subcarrier spacing, the number of subcarriers, the cyclic prefix ratio, and the number of symbols of the T-ISAC system.

6. The method according to claim 4, wherein the determining a subcarrier spacing, the number of subcarriers, a cyclic prefix ratio, and the number of symbols of the T-ISAC system based on the 6G application scene requirements, the first association relationship, and the second association relationship comprises:
calculating a parameter feasible region of the OFDM frame structure based on the first association relationship and the second association relationship under the condition of meeting the 6G application scene requirements, wherein the parameter feasible region comprises the subcarrier spacing, the number of subcarriers, the cyclic prefix ratio, and the number of symbols.

7. An integrated sensing and communication waveform generation device, which is applied to a T-ISAC system comprising a sparse MIMO linear array, and which comprises:
an acquisition module, which is configured to acquire a downlink integrated signal received by a user device and acquire an integrated signal echo received by the T-ISAC system during a communication process between the T-ISAC system and the user device implemented through the sparse MIMO linear array;
a construction module, which is configured to construct a first association relationship for characterizing a relationship between downlink communication performance of the user device and T-ISAC system parameters based on the downlink integrated signal, and construct a second association relationship for characterizing a relationship between communication and sensing performances of the user device and the T-ISAC system parameters based on the integrated signal echo, wherein the system parameters are system operating parameters required for constructing integrated waveforms; and
a generation module, which is configured to obtain an OFDM frame structure design of the T-ISAC system based on the first association relationship and the second association relationship, and control the T-ISAC system to generate integrated waveforms based on the OFDM frame structure design.

8. An electronic device, comprising:
a memory, which is configured to store executable instructions; and
a processor, which is configured to execute the executable instructions with the memory to complete operations of the integrated sensing and communication waveform generation method according to claim 1.

9. A computing device readable storage medium, which is configured to store instructions readable by a computing device, wherein when the instructions are executed, operations of the integrated sensing and communication waveform generation method according to claim 1 are performed.
